(19) United States
(12) Patent Application Publication
(10) Pub. No.: US 2026/0145409 A1
(43) Pub. Date: May 28, 2026

(54) SEALING FILM AND CONTAINER COMPRISING SEALING FILM

(71) Applicant: ALPLA Werke Alwin Lehner GmbH & Co. KG, Hard (AT)

(72) Inventor: Robert SIEGL, Dornbirn (AT)

(73) Assignee: ALPLA Werke Alwin Lehner GmbH & Co. KG, Hard (AT)

(21) Appl. No.: 18/997,375

(22) PCT Filed: Jul. 25, 2023
(86) PCT No.: PCT/EP2023/070650

§ 371 Date: Jan. 21, 2025

(30) Foreign Application Priority Data
Jul. 26, 2022 (CH) CH000894/2022

(51) Int. Cl. B32B 27/08; B32B 27/32; B32B 27/36

(52) U.S. Cl. CPC B32B 27/08; B32B 27/32; B32B 27/36; B32B 2250/03; B32B 2250/24; B32B 2264/101; B32B 2264/2032; B32B 2266/025; B32B 2307/72; B32B 2439/02; B32B 2581/00

(57) ABSTRACT

A sealing film for sealing off a container opening, and a container comprising a sealing film. The sealing film comprises a carrier film and a cover film. Between the carrier film and the cover film is arranged a binding layer for connecting the carrier film to the cover film and having a melting point of less than 120° C.

The present invention relates to a sealing film for sealing off a container opening and to a container comprising a sealing film according to the preamble of the independent claims.

Many containers, in particular for foodstuffs, are known from the prior art. Different types of containers have become established for certain products or product groups. In particular in the case of containers containing a perishable product, the containers are to be sealed with sealing films. Such products are often milk-based products such as yogurt.

Yogurt beakers are typically made of polypropylene or polystyrene and sealed by means an aluminum foil or a metallized film. Typically, these films are printed or laminated on one side. This printing or lamination has, firstly, the purpose of protecting the metal from corrosion and, secondly, an aesthetic purpose for promoting the product, i.e. the contents.

These coatings are typically made of plastics such as unsaturated polyester resins or epoxy resins. These are very difficult, if not impossible, to recycle. In addition, if the film is at least properly separated from the associated beaker and recycled separately, the film is typically fed to a metal recycling process. This contaminates the recycling stream and also leads to incorrect recording of the amount recycled.

Even if the consumer separates the individual constituents correctly, recycling companies are faced with the task of separating the films into their constituents in order to separate the materials.

However, the film is often not separated from the associated beaker and remains in the polymer recycling stream. Considerable effort must be made to remove foreign materials such as metal or coating from this stream.

Metal-free solutions have also already become known in the prior art. Polyester packagings are sealed by means of a polyolefin film, which in turn is laminated with an LDPE sealing film. This material pairing is undesirable in recycling because it is very difficult to separate.

It is therefore an object of the invention to eliminate at least one or more disadvantages of the prior art. In particular, a sealing film is to be created which makes possible an easy and preferably essentially complete recycling. This means more portions of packagings can be recycled.

This object is achieved by the devices defined in the independent claims. Further embodiments result from the dependent claims.

A sealing film according to the invention for sealing off a container opening comprises a carrier film and a cover film. A binding layer is arranged between the carrier film and the cover film in order to connect the carrier film to the cover film. The binding layer has a melting point of less than 100° C. Preferably, the binding layer has a melting point of less than 80° C., the melting point lying between 60° C. and 80° C. in particular.

The sealing film comprises a plurality of films, namely a cover film and a carrier film. The carrier film is intended to seal a container. The cover film is intended to receive various applications such as an imprintment, coating or other decoration.

The binding layer connects the carrier film to the cover film. Due to the low melting point of less than 100° C., the cover film can be removed from the carrier film by the effect of elevated temperature. This allows the cover film and the carrier film to be easily separated so that they can each be fed into a separate recycling stream. The low melting point ensures that the energy input does not have to be very high, and also that neither the carrier film nor the cover film unnecessarily deforms or sticks.

This low melting point also makes it possible to separate the carrier film from the cover film in a warm water bath. Accordingly, with this relatively simple means a separate recycling stream can be created not only for the carrier film but also for the cover film.

The carrier film and/or the cover film are preferably directly connected to the binding layer. This ensures that the film in question can be separated from the binding layer by the appropriate energy input.

Not only the carrier film but also the cover film are essentially diffusion-tight with respect to the binding layer. In other words, the binding layer does not diffuse into the adjacent films but rather adheres to the cover film and to the carrier film.

The carrier film preferably has a density that is greater than 1 g/cm³ , in particular greater than 1.2 g/cm³ . These densities are higher than the density of water at room temperature. Accordingly, these densities cause a corresponding carrier film to sink downward in a stream of water and, for example, to sink to the bottom in a basin and be discharged from there.

Preferably, the carrier film has a diffusion value for oxygen of less than 0.5 cm³/m²/d and a diffusion value for water vapor of less than 0.3 g/m²/d.

With these values, the minimum requirements for the sealing tightness of a closure, in the present case a seal, are met. It is guaranteed that the products contained in a container sealed by means of this sealing film can have a minimum shelf life. Firstly, these values prevent the product from drying out too quickly, and secondly, they prevent too much oxygen from diffusing into the product and triggering undesirable oxidation processes.

The sealing film is preferably made of a material from the following list: polyester, in particular PET, PEF or PEN, copolymers with isosorbitol, isophthalic acid or diethylene glycol, mixtures with polyamide, in particular comprising oxygen absorber or UV blocker.

These are particularly suitable materials that meet the desired requirements, and these materials also can be recycled relatively well and easily in existing recycling processes.

Preferably, the cover film has a density of less than 0.95 g/cm³. This density is lower than the density of water at 100° C. Due to this low density, the cover film floats on top in a water bath and, accordingly, can be discharged at the top, for example in a basin.

Overall, the present configuration allows the sealing film to be easily separated into its individual components in a warm water bath and allows the individual films, i.e. the carrier film and the cover film, to each be fed into a separate recycling stream.

One aspect thus also relates to the use of a water bath for separating sealing films having a binding layer such as are described here. Preferably, the water bath is warm, in particular heated to a temperature above the melting temperature of the binding layer.

Preferably, the density of the cover film is between 0.9 and 0.94 g/cm³. The lower the density, the better the cover film floats on top.

The cover film can be made of a material selected from the following list: polyolefins, in particular polypropylene, polystyrene, polyester; said materials can additionally be foamed and/or voided.

In voiding, defects are deliberately introduced so that holes are formed when the film is stretched. In foaming, the pores are present from the beginning, even before the film is stretched.

Some of the materials are naturally low-density, so they float on top in water. If the materials have a higher density, foaming or voiding is a suitable measure for reducing the relative density.

In particular, it may be provided that additives such as hollow glass spheres are introduced in order to further reduce the density.

The cover film can have an application, in particular an imprintment or coating, for example with ink and/or plastic and/or metal.

By corresponding application of an additional material as described here, for example the properties of the sealing film can be further improved. In addition, an attractive appearance and/or information about the contents of the container sealed by means of the sealing film can be provided. If necessary, an appealing feel can also be provided.

Preferably, the cover film together with the application has a density of less than 0.95 g/cm³.

This ensures that the cover film together with the application thereon still floats on top in a water bath and can be easily separated from the carrier film.

It can be provided that, for density reduction, the application comprises additives such as hollow glass spheres and/or is foamed and/or voided.

Preferably, the binding layer has a melting point of at least 50° C. This ensures that the sealing film can perform its function even at elevated temperatures and that the cover film is not inadvertently separated from the carrier film.

The binding layer is selected in particular from a material from the following list: wax, paraffin.

These materials are inexpensive to obtain and can be easily processed. A connection between a cover film and a carrier film is easy to create using wax or paraffin. This material of the binding layer can also be relatively easily removed from the recycling cycle.

In a preferred embodiment, the sealing film has a carrier film made of PET which is directly connected to a cover film made of PP by means of a binding layer made of wax. A carrier film made of PET with a cover film made of PP with a material thickness per film of more than 0.1 mm is preferred. Preferably, the films are thinner than 0.5 mm, in particular thinner than 0.3 mm.

Alternatively, it is also possible to use a carrier film made of PET and a cover film made of foamed HDPE.

A further aspect relates to a container having a container opening, wherein the container opening is closed by means of a sealing film as described here. This allows the provision of a specific material pairing between container, cover film and carrier film which is easily recyclable and, in particular, the individual elements can be easily separated.

It may be provided that the material of the carrier film is compatible with the material of the container and in particular can be recycled together with the container.

For example, the container can be made of PET and the carrier film can likewise be made of PET. The cover film can be made of polypropylene. PET typically has a density of 1.33 g/cm³ and therefore sinks in water. Polypropylene has a density of 0.9 g/cm³ to 0.96 g/cm³ and therefore floats on water. In other words, the container and the cover film can thus be discharged together at the bottom of a water bath and the cover film can be discharged from the upper region of the water bath.

The container preferably has an average wall thickness of less than 0.5 mm.

The invention is explained below with reference to schematic figures. In the figures:

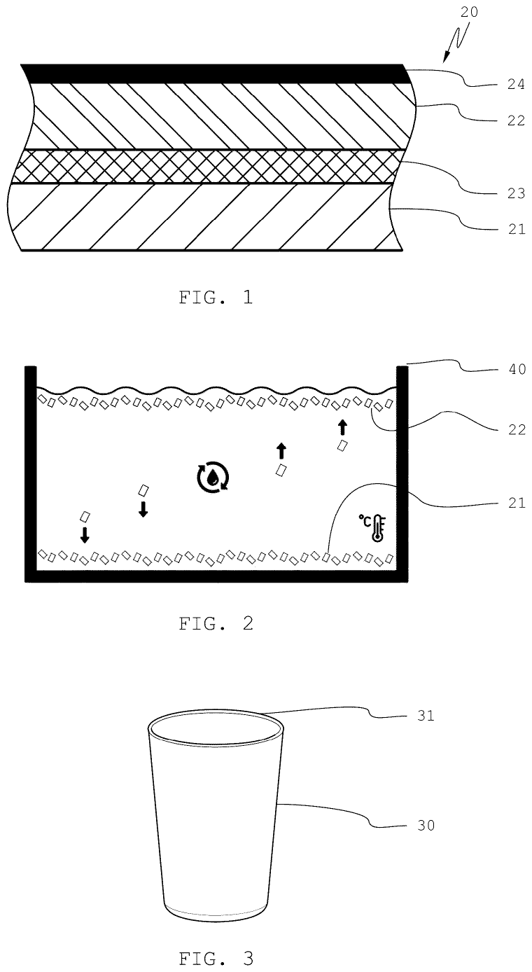

FIG. 1: shows a cross-section through a sealing film;

FIG. 2: shows a recycling stream;

FIG. 3: shows a container.

FIG. 1 shows a cross-section through a sealing film 20. The sealing film 20 comprises a carrier film 21 and a cover film 22. The carrier film 21 is connected to the cover film 22 by means of a binding layer 23. In the present case, the binding layer 23 is made of wax and is directly connected to the carrier film 21 and to the cover film 22. The binding layer 23 has a thickness between 0.1 mm and 0.5 mm. An application 24, which in the present case is in the form of a colored coating, is applied to the cover film 22. The carrier film is made of PET and has a thickness of 0.1 mm. The cover film is made of PP and likewise has a thickness of 0.1 mm.

FIG. 2 shows a recycling stream; in particular, FIG. 2 shows a water bath 40 in which the individual materials are separated. As can be seen from FIG. 2, the cover film 22 floats on top due to having a lower density than water and the carrier film 21 sinks downward. In the present case, the water is heated above the melting temperature of the binding layer, in the present case to a temperature of 70° C. Due to the heated water, the binding layer 23 melts and the carrier film 21 can separate from the cover film 22.

FIG. 3 shows a container 30 having an opening 31 which is typically closed off by means of a sealing film 20 such as is described here.

1. A sealing film (20) for sealing off a container opening (31), comprising
a carrier film (21) and a cover film (22),
wherein
a binding layer (23) having a melting point of less than 100° C. is arranged between the carrier film (21) and the cover film (22) in order to connect the carrier film (21) to the cover film (22).

2. The sealing film (20) according to claim 1, wherein the carrier film (21) and/or the cover film (22) are directly connected to the binding layer (23).

3. The sealing film (20) according to claim 1, wherein the carrier film (21) has a density which is greater than 1 g/cm³, in particular greater than 1.2 g/cm³.

4. The sealing film (20) according to claim 1, wherein the carrier film (21) has a diffusion value for oxygen of less than 0.5 cm³/m²/d and a diffusion value for water vapor of less than 0.3 g/m²/d.

5. The sealing film (20) according to claim 1, wherein the carrier film (21) is made of a material from the following list: polyester, in particular PET, PEF or PEN, copolymers with isosorbitol, isophthalic acid or diethylene glycol, mixtures with polyamide, in particular comprising oxygen absorber or UV blocker.

6. The sealing film (20) according to claim 1, wherein the cover film (22) has a density of less than 0.95 g/cm³, in particular between 0.9 g/cm³ and 0.94 g/cm³.

7. The sealing film (20) according to claim 1, wherein the cover film (22) is made of a material from the following list: polyolefins, in particular polypropylene, polystyrene, polyester, wherein said materials can additionally be foamed and/or voided.

8. The sealing film (20) according to claim 6, wherein the cover film (22) comprises additives, in particular hollow glass spheres.

9. The sealing film (20) according to claim 1, wherein an application (24) is applied to the cover film (22).

10. The sealing film (20) according to claim 7, wherein the cover film (22) with the application (23) has a density of less than 0.95 g/cm³.

11. The sealing film (20) according to claim 9, wherein the application (24) comprises additives, in particular hollow glass spheres, and/or is foamed and/or voided to reduce the density.

12. The sealing film (20) according to claim 1, wherein the binding layer (23) has a melting point of less than 100° C., in particular a melting point of less than 80° C.

13. The sealing film (20) according to claim 1, wherein the binding layer (23) has a melting point of at least 50° C.

14. The sealing film (20) according to claim 1, wherein the binding layer (23) is selected from a material from the following list: wax, paraffin.

15. A container (30) having a container opening (31), wherein the container opening is closed by means of a sealing film (20) according to claim 1.
